(19) United States
(12) Patent Application Publication
(10) Pub. No.: US 2017/0237477 A1
(43) Pub. Date: Aug. 17, 2017

(54) BASE STATION, COMMUNICATION SYSTEM, AND REFERENCE SIGNAL TRANSMISSION METHOD

(71) Applicant: FUJITSU LIMITED, Kawasaki-shi (JP)

(72) Inventors: Shunsuke FUJIO, Kawasaki (JP); Dai Kimura, Yokohama (JP)

(73) Assignee: FUJITSU LIMITED, Kawasaki-shi (JP)

(21) Appl. No.: 15/583,754

(22) Filed: May 1, 2017

Related U.S. Application Data
(63) Continuation of application No. PCT/JP2014/081332, filed on Nov. 27, 2014.

(51) Int. Cl. H04B 7/06; H04L 5/00; H04W 16/28

(52) U.S. Cl. CPC H04B 7/0617; H04W 16/28; H04L 5/0048

(57) ABSTRACT

A base station that performs beamforming on a user equipment includes an acquiring unit that acquires a distribution of propagation losses in a communication area, a deciding unit that decides a beam set formed by a plurality of beams that are used for channel estimation, each of the beams having a beam width based on the distribution, and an antenna that transmits a reference signal to the user equipment by using each of the beams that form the beam set.

### CROSS-REFERENCE TO RELATED APPLICATION

This application is a continuation of International Application No. PCT/JP2014/081332, filed on Nov. 27, 2014, the entire contents of which are incorporated herein by reference.

### FIELD

The embodiments discussed herein are related to a base station, a communication system, and a reference signal transmission method.

### BACKGROUND

In recent years, with an increase in the number of radio communication devices, speeding up of communication speed, and an increase in the communication band width, there is a growing need for improving the use efficiency of the radio resource (for example, frequency use efficiency).

There is “beamforming” as a technology to improve the use efficiency of the radio resource. For example, a base station that uses beamforming controls the phase and the amplitude of a data signal addressed to user equipment (UE) by multiplying a weight vector by the data signal addressed to the user equipment. In the base station, by adjusting the weight vector, a radio wave is possible to be concentrated by directing a beam toward the area in which the user equipment is located. Consequently, it is possible to reduce interference with the radio wave of the other communication and, as a result, it is possible to improve the frequency use efficiency. In particular, an antenna element held by a radio communication device that performs high frequency and wide bandwidth communication, such as millimeter wave communication, is small. Furthermore, in general, propagation losses of a radio signal having a high frequency are great. Consequently, a radio communication device that performs communication in high frequency and wide bandwidth usually compensates propagation losses by using beamforming.

In order to enhance the effect of interference reduction, it is important for the base station that performs beamforming to decide an appropriate beam to be a beam that is used to transmit a data signal (hereinafter, sometimes referred to as a “data transmission beam”). Consequently, when a data transmission beam is decided, a “beam search” that searches a plurality of “candidate beams” for an appropriate data transmission beam is performed.

In the beam search, the base station transmits reference signals (hereinafter, sometimes referred to as “RSs”) to user equipment by sequentially switching candidate beams from among a plurality of predetermined candidate beams. The user equipment performs channel estimation for each candidate beam by using the reference signals and reports a channel estimated value for each candidate beam to the base station. Namely, the “candidate beam” is possible to also be referred to as a “reference signal transmission purpose beam” or a “channel estimation purpose beam”. On the basis of the channel estimated value for each candidate beam reported from the user equipment, the base station decides a data transmission beam with respect to the subject user equipment. For example, the base station decides the candidate beam, in which the Reference Signal Received Power (RSRP) in the user equipment is the maximum from among the plurality of the candidate beams, as a data transmission beam with respect to the subject user equipment. In this way, in the beam search, an appropriate beam is decided to be a data transmission beam for each of the pieces of user equipment from among the plurality of the predetermined candidate beams.

Examples of related-art are described in Japanese Laid-open Patent Publication No. 2013-232741, in Japanese National Publication of International Patent Application No. 2003-521822, and in T. Kim, J. Park, J.-Y. Seol, S. Jeong, J. Cho and W. Roh, “Tens of Gbps Support with mmWave Beamforming Systems for Next Generation Communications” in Proc. IEEE Global Commun. Conf. (GLOBECOM), pp. 3790-3795, December 2013.

Here, the gain obtained by the beamforming (hereinafter, sometimes referred to as “BF gain”) becomes large as the beam width is smaller. Thus, conventionally, in order to obtain sufficient channel estimation accuracy even if user equipment is located at the edge of a cell, the beam width of all of the candidate beams is uniformly set to a small width. In contrast, in order to evenly fill a certain sized cell with a plurality of candidate beams, the number of candidate beams is increased as the beam width is smaller. Furthermore, as the number of candidate beams is increased, consumption of the radio resource is increased. Consequently, conventionally, many radio resources are consumed for the beam search. Because there is an upper limit for the radio resources that are possible to be used in a single cell, if a lot of radio resources are consumed for the beam search, the radio resources available for transmission of data signals is decreased and, consequently, the overall throughput in the cell is decreased. Furthermore, because the position of the user equipment varies every moment, in order to change a data transmission beam to an appropriate beam by following the variation in the position of the user equipment, it is preferable that the operation interval of the beam search be smaller. However, because more radio resources are consumed as the operation interval of the beam search is shorter, the rate of a decrease in overall throughput in the cell is accordingly increased.

Furthermore, a “cell” is defined on the basis of a “communication area” and a “channel frequency” of a single base station. The “communication area” mentioned here may also be the overall area (hereinafter, sometimes referred to as a “range area”) in which a radio wave transmitted from a base station arrives or may also be a division area (so called a sector) obtained by dividing the range area. Furthermore, the “channel frequency” mentioned here is a unit of frequency used for communication by the base station and is defined based on both the center frequency and the bandwidth.

### SUMMARY

According to an aspect of an embodiment, a base station that performs beamforming on a user equipment includes an acquiring unit that acquires a distribution of propagation losses in a communication area, a deciding unit that decides a beam set formed by a plurality of beams that are used for channel estimation, each of the beams having a beam width based on the distribution, and an antenna that transmits a reference signal to the user equipment by using each of the beams that form the beam set.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating an example of a communication system according to a first embodiment;

FIG. 2 is a schematic diagram illustrating an example of the communication system according to the first embodiment;

FIG. 3 is a functional block diagram illustrating an example of a base station according to the first embodiment;

FIG. 4 is a functional block diagram illustrating an example of user equipment according to the first embodiment;

FIG. 5 is a schematic diagram illustrating an example of the processing sequence in the communication system according to the first embodiment;

FIG. 6 is a flowchart illustrating the flow of a process performed in the base station according to the first embodiment;

FIG. 7 is a schematic diagram illustrating an example of a distribution of propagation losses according to the first embodiment;

FIG. 8 is a schematic diagram illustrating a decision process of a candidate beam set according to the first embodiment;

FIG. 9 is a schematic diagram illustrating a decision process of a candidate beam set according to the first embodiment;

FIG. 10 is a schematic diagram illustrating an example of an estimation result of RSRP according to the first embodiment;

FIG. 11 is a schematic diagram illustrating an example of candidate beam sets according to the first embodiment;

FIG. 12 is a functional block diagram illustrating an example of a base station according to a second embodiment;

FIG. 13 is a functional block diagram illustrating an example of user equipment according to the second embodiment;

FIG. 14 is a flowchart illustrating the flow of a process performed in the base station according to the second embodiment;

FIG. 15 is a schematic diagram illustrating an example of an estimation result of the reception quality according to the second embodiment;

FIG. 16 is a schematic diagram illustrating an example of a candidate beam set according to the second embodiment;

FIG. 17 is a functional block diagram illustrating an example of a base station according to a third embodiment;

FIG. 18 is a functional block diagram illustrating an example of user equipment according to the third embodiment;

FIG. 19 is a schematic diagram illustrating an example of the processing sequence in a communication system according to the third embodiment;

FIG. 20 is a flowchart illustrating the flow of a process performed in a candidate beam set re-deciding unit according to the third embodiment;

FIG. 21 is a schematic diagram illustrating an example of a re-decision candidate beam set according to the third embodiment;

FIG. 22 is a schematic diagram illustrating an example of the hardware configuration of the base station; and

FIG. 23 is a schematic diagram illustrating an example of the hardware configuration of the user equipment.

### DESCRIPTION OF EMBODIMENTS

Preferred embodiments of the present invention will be explained with reference to accompanying drawings. The base station, the communication system, and the reference signal transmission method disclosed in the present invention are not limited to the embodiments. Furthermore, in the embodiments described below, components that have the same function and steps at each of which the same process is performed are assigned the same reference numerals; therefore, descriptions of overlapped portions will be omitted.

### [a] First Embodiment

Outline of the Communication System

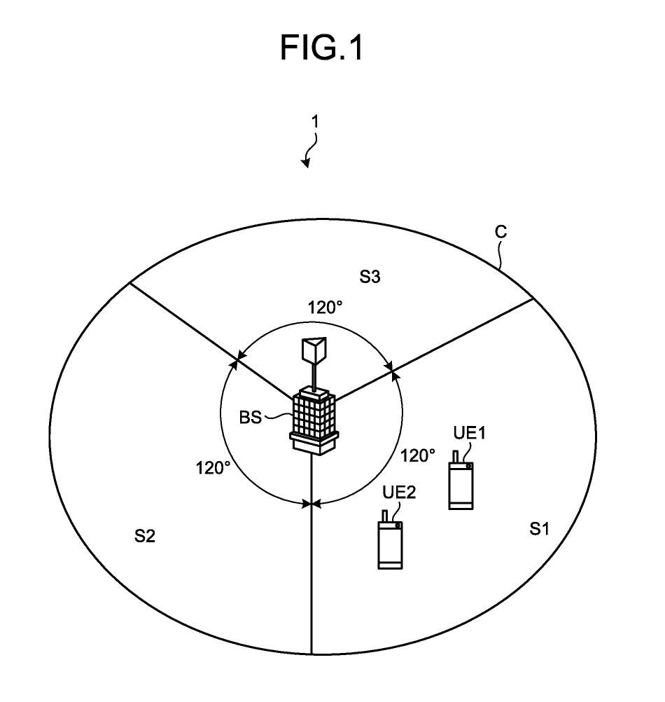

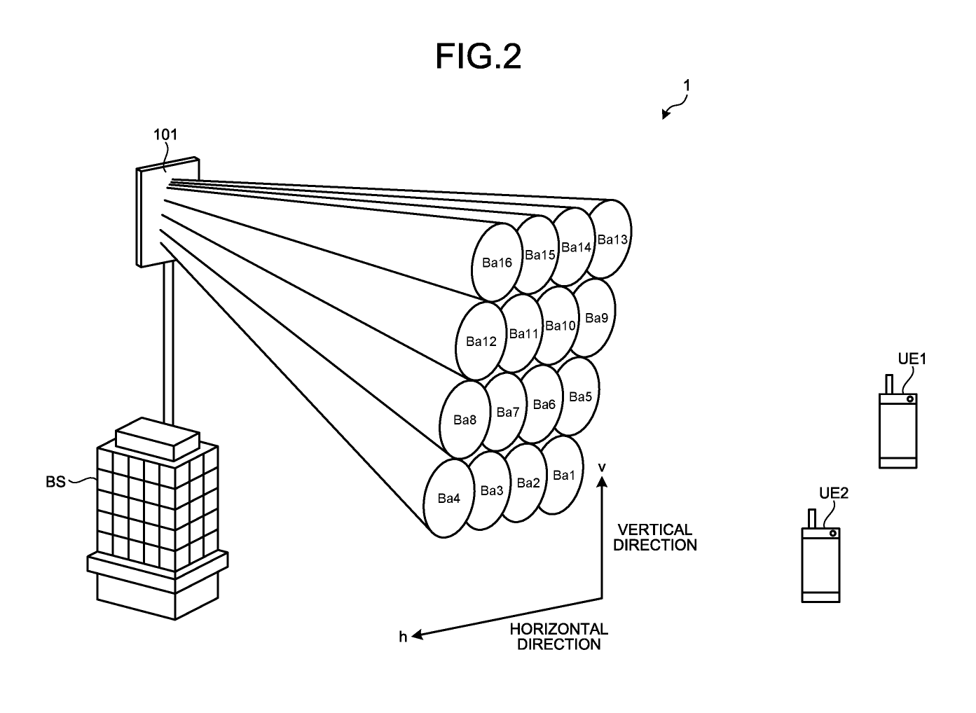

FIGS. 1 and 2 are schematic diagrams each illustrating an example of a communication system according to a first embodiment. In FIG. 1, a communication system 1 includes a base station BS and user equipment UE1 and UE2. The base station BS forms a cell C. The cell C is divided into three sectors, i.e., sectors S1, S2, and S3, and, for example, the user equipment UE1 and UE2 are located in the sector S1. The base station BS includes, for example, three flat panel antennas that form the respective sector S1, S2, S3 and each of which covers the respective communication area of 120° in the horizontal direction. In a description below, if pieces of the user equipment UE1 and UE2 are not particularly distinguished, the pieces of the user equipment UE1 and UE2 are sometimes simply referred to as the “user equipment UE”.

As illustrated in FIG. 2, the base station BS includes a flat panel antenna 101 associated with, for example, the sector S1 and transmits a reference signal to the user equipment UE by using each of candidate beams Ba1 to Ba16 that are formed by using the flat panel antenna 101. Each of the pieces of the user equipment UE performs channel estimation for each candidate beam, i.e., the candidate beams Ba1 to Ba16, by using reference signals transmitted from the base station BS. Furthermore, as illustrated in FIG. 2, the emission directions of the candidate beams Ba1 to Ba16 are different with each other. Namely, in the horizontal direction (in the direction of h), the sum of the beam width of the four candidate beams corresponds to the communication area of the sector S1 illustrated in FIG. 1. Furthermore, the emission region of the candidate beam in the vertical direction (in the direction of v) is set to a predetermined region, such as a region from 0° to, for example, 120° in the vertical downward direction with reference to a predetermined spot on the flat panel antenna 101. Consequently, the entire communication area of the sector S1 is covered by the candidate beams Ba1 to Ba16. In a description below, a set of beams formed by a plurality of candidate beams that covers the entirety of a single communication area is sometimes referred to as a “candidate beam set”. Namely, in FIG. 2, the candidate beam set is formed by 16 candidate beams of the candidate beams Ba1 to Ba16. Thus, in other words, the “candidate beam set” is formed by a plurality of beams used for channel estimation or is formed by a plurality of beams used for transmission of the reference signals.

Configuration of the Base Station

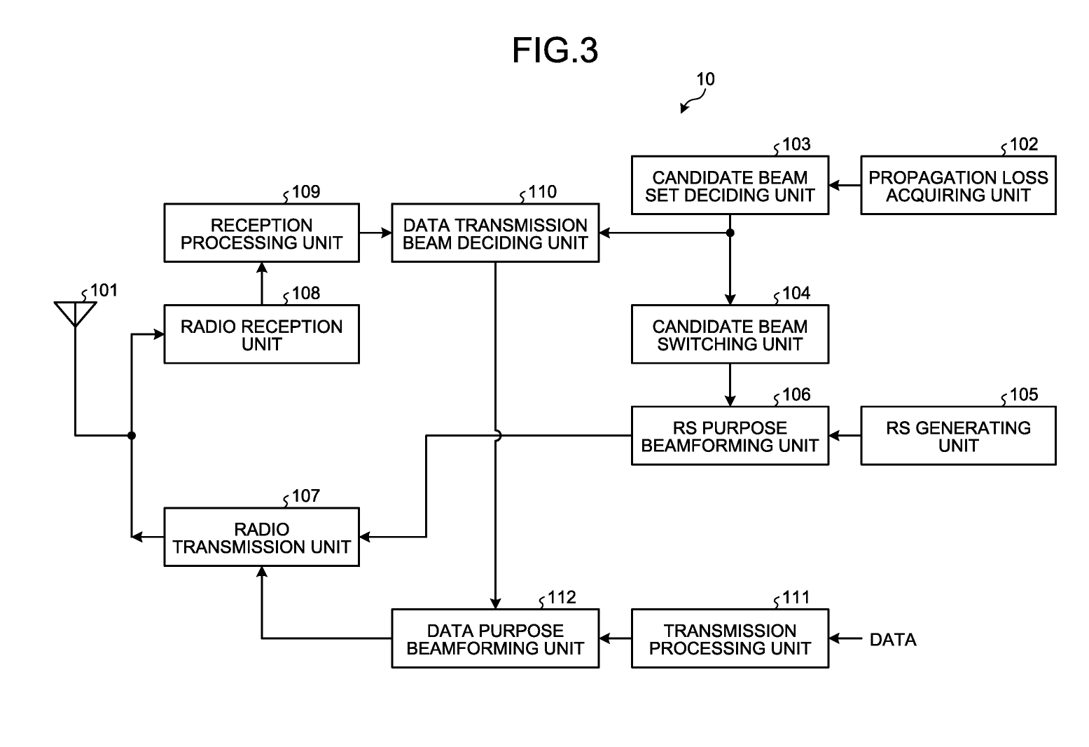

FIG. 3 is a functional block diagram illustrating an example of the base station according to the first embodiment. A base station 10 illustrated in FIG. 3 corresponds to the base station BS illustrated in FIGS. 1 and 2. In FIG. 3, the base station 10 includes the flat panel antenna 101, a propagation loss acquiring unit 102, a candidate beam set deciding unit 103, and a candidate beam switching unit 104. Furthermore, the base station 10 includes an RS generating unit 105, an RS purpose beamforming unit 106, a radio transmission unit 107, a radio reception unit 108, a reception processing unit 109, a data transmission beam deciding unit 110, a transmission processing unit 111, and a data purpose beamforming unit 112.

The flat panel antenna 101 includes a total of 16 antenna elements, i.e., for example, four antenna elements in each of the horizontal direction and the vertical direction. The base station 10 performs beamforming by using the flat panel antenna 101.

The propagation loss acquiring unit 102 acquires a distribution of propagation losses in the sector S1 and outputs information on the acquired distribution of the propagation losses to the candidate beam set deciding unit 103. The acquisition of the distribution of the propagation losses will be described in detail later.

The candidate beam set deciding unit 103 decides a candidate beam set in the sector S1 on the basis of the distribution of the propagation losses acquired by the propagation loss acquiring unit 102 and instructs both the candidate beam switching unit 104 and the data transmission beam deciding unit 110 of the decided candidate beam set. The decision of the candidate beam set will be described in detail later.

The candidate beam switching unit 104 instructs the RS purpose beamforming unit 106 of the candidate beams while sequentially changing, in accordance with elapse of time in a beam search, the candidate beams used for transmission of the reference signals from among a plurality of candidate beams that forms a candidate beam set.

The RS generating unit 105 generates the reference signals and outputs the generated reference signals to the RS purpose beamforming unit 106.

The RS purpose beamforming unit 106 performs beamforming on the reference signals in accordance with the candidate beams instructed from the candidate beam switching unit 104 and outputs the reference signals that have been subjected to beamforming to the radio transmission unit 107.

For example, by using the weight of the candidate beams instructed from the candidate beam switching unit 104, the RS purpose beamforming unit 106 controls the phase or controls of the combination of the phase and the amplitude of the reference signals transmitted from each of the antenna elements included in the flat panel antenna 101. If the number of all of the antenna elements included in the flat panel antenna 101 is M, the reference signals x_{m,n} (m=0, 1, . . . , and M−1) that have been subjected to beamforming and that is transmitted from an antenna element m by using a candidate beam n are represented by Equation (1), where w_{m,n} is the weight with respect to the antenna element m of the candidate beam n and sₘ is the reference signal before the beamforming.

x_{m,n}=w_{m,n}sₘ (1)

The transmission processing unit 111 generates a baseband data signal by performing a baseband process of encoding and modulating the input data and then outputs the generated baseband data signal to the data purpose beamforming unit 112.

The radio transmission unit 107 performs a radio process of digital-to-analog conversion and up-conversion on the reference signals that are input from the RS purpose beamforming unit 106 and the data signal that is input from the data purpose beamforming unit 112. The radio transmission unit 107 transmits the RS signal and the data signal that have been subjected to the radio process to the user equipment UE via the flat panel antenna 101.

The radio reception unit 108 performs a radio process of down-conversion and analog-to-digital conversion on a report signal received from the user equipment UE via the flat panel antenna 101, obtains a baseband report signal, and outputs the obtained report signal to the reception processing unit 109. In the report signal received from the user equipment UE, a channel estimated value for each candidate beam is included.

The reception processing unit 109 performs a baseband process of demodulating and decoding on the baseband report signal and acquires a channel estimated value for each candidate beam included in the report signal received from each of the pieces of user equipment UE. The channel estimated value is a combination of RSRP for each candidate beam in the user equipment UE or RSRP for each candidate beam and a phase rotation amount for each candidate beam in a propagation path from the base station 10 to the user equipment UE. The reception processing unit 109 outputs the channel estimated value for each candidate beam reported from each of the pieces of user equipment UE to the data transmission beam deciding unit 110.

The data transmission beam deciding unit 110 decides a data transmission beam based on the candidate beam set instructed from the candidate beam set deciding unit 103 and based on the channel estimated value for each of the pieces of user equipment UE and for each candidate beam that are input from the reception processing unit 109. The data transmission beam deciding unit 110 instructs the data purpose beamforming unit 112 of the information on the weight vector that is used to form the decided data transmission beam.

For example, if the channel estimated value reported from the user equipment UE is the RSRP for each candidate beam in the user equipment UE, the data transmission beam deciding unit 110 decides a data transmission beam as follows. Namely, the data transmission beam deciding unit 110 decides the candidate beam with the highest RSRP from among the plurality of the candidate beams that form the candidate beam set as the data transmission beam.

Furthermore, for example, if the channel estimated value reported from the user equipment UE is a combination of the RSRP for each candidate beam and the phase rotation amount, the data transmission beam deciding unit 110 decides a data transmission beam as follows. Namely, the data transmission beam deciding unit 110 performs a linear combination on the weight vector of the candidate beam by using the weight in accordance with the channel estimated value and decides the beam formed by the weight vector that has been subjected to the linear combination as the data transmission beam. The weight vector ŵ that has been subjected to the linear combination is represented by, for example, Equation (2), where N is the number of candidate beams that form a candidate beam set, wₙ (n=0, 1, . . . , and N−1) is the weight vector of the candidate beam n, and hₙ̂* is the weight in accordance with the channel estimated value with respect to the candidate beam n. Furthermore, hₙ̂* is represented by Equation (3), where, Pₙ is RSRP (true value) and φₙ is a phase rotation amount. Furthermore, the weight vector ŵ may also be normalized.

$$\begin{matrix}\hat{w} = {\sum }_{n = 0}^{N - 1} {w}_{n} {\hat{h}}_{n}^{*} & ( 2 ) \\ {\hat{h}}_{n}^{*} = \sqrt{{P}_{n}} exp ( - j {φ}_{n} ) & ( 3 )\end{matrix}$$

The data purpose beamforming unit 112 performs beamforming on the data signal based on the information on the weight vector instructed from the data transmission beam deciding unit 110 and then outputs the data signal that has been subjected to the beamforming to the radio transmission unit 107. For example, the data signals yₘ (m=0, 1, . . . , and M−1) that have been subjected to beamforming and that are transmitted from the antenna element m are represented by Equation (4), where wₘ̂ is the m^{th} element of the weight vector ŵ and dₘ is a data signal before the beamforming.

yₘ=ŵₘdₘ (4)

Configuration of the User Equipment

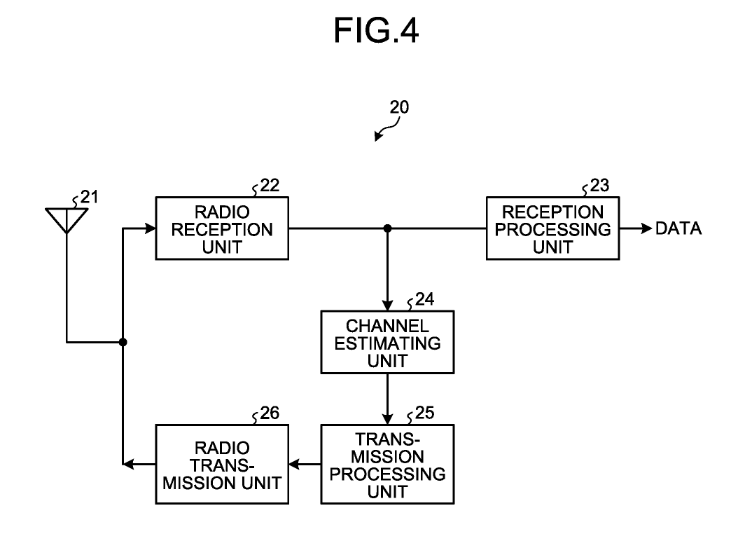

FIG. 4 is a functional block diagram illustrating an example of the user equipment according to the first embodiment. User equipment 20 illustrated in FIG. 4 corresponds to the user equipment UE1 and UE2 illustrated in FIGS. 1 and 2. In FIG. 4, the user equipment 20 includes an antenna 21, a radio reception unit 22, a reception processing unit 23, a channel estimating unit 24, a transmission processing unit 25, and a radio transmission unit 26.

The radio reception unit 22 performs a radio process of down-conversion and analog-to-digital conversion on the reference signal and the data signal received from the base station 10 via the antenna 21, obtains a baseband reference signal and a baseband data signal, and outputs the signals to the reception processing unit 23 and the channel estimating unit 24.

The reception processing unit 23 acquires data by performing a baseband process of demodulating and decoding the baseband data signal.

The channel estimating unit 24 performs channel estimation by using the reference signal and outputs the channel estimated value to the transmission processing unit 25. For example, the channel estimating unit 24 measures, as the channel estimated value, the RSRP for each candidate beam. Alternatively, the channel estimating unit 24 measures, as the channel estimated value, the RSRP and the phase rotation amount for each candidate beam. The channel estimating unit 24 generates report data including the channel estimated values for the plurality of respective candidate beams and then outputs the report data to the transmission processing unit 25. The channel estimation performed by the channel estimating unit 24 is performed in synchronization with the transmission timing of the reference signal from the base station 10. For example, the transmission timing of the reference signal from the base station 10 is previously set to a predetermined timing and is also known to the user equipment 20.

The transmission processing unit 25 generates a baseband report signal by performing a baseband process of encoding and modulating the report data and then outputs the generated baseband report signal to the radio transmission unit 26.

The radio transmission unit 26 performs a radio process of digital-to-analog conversion and up-conversion on the baseband report signal. The radio transmission unit 26 transmits the report signal that has been subjected to the radio process to the base station 10 via the antenna 21.

Process in the Communication System

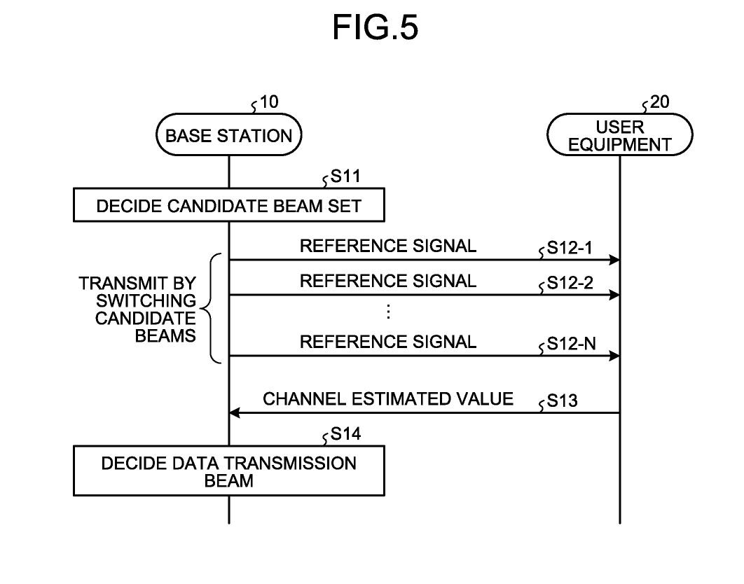

FIG. 5 is a schematic diagram illustrating an example of the processing sequence in the communication system according to the first embodiment.

First, the base station 10 decides a candidate beam set (Step S11).

Then, the base station 10 switches the candidate beams included in the candidate beam set and transmits reference signals (Steps S12-1 to S12-N, where N is the number of candidate beams that form the candidate beam set).

Then, the user equipment 20 reports the channel estimated value for each candidate beam to the base station 10 (Step S13).

Then, the base station 10 decides a data transmission beam based on the channel estimated value for each candidate beam (Step S14).

Process in the Base Station

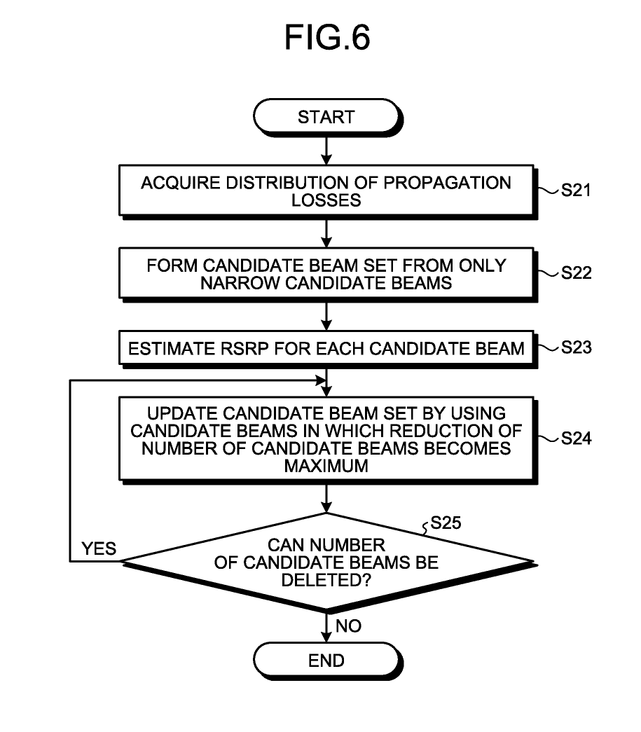

FIG. 6 is a flowchart illustrating the flow of a process performed in the base station according to the first embodiment. In the following, a description will be given of a case in which a candidate beam set is formed by two types of candidate beams, i.e., a “narrow candidate beam” that has a predetermined beam width and a “wide candidate beam” that has the beam width greater than that of the narrow candidate beam. The flowchart illustrated in FIG. 6 is started at a predetermined interval.

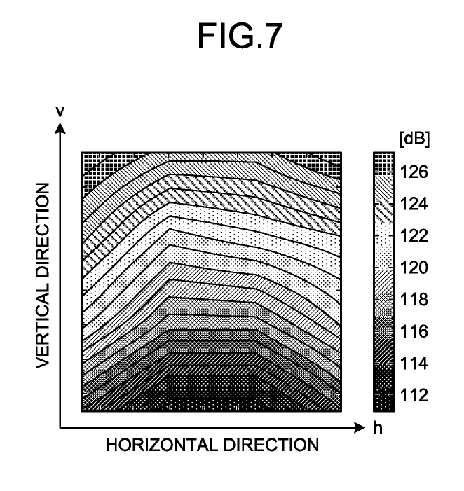

In FIG. 6, first, the propagation loss acquiring unit 102 acquires the distribution of the propagation losses in the sector S1 (Step S21). The propagation loss acquiring unit 102 uses propagation simulation by taking into consideration, for example, three-dimensional building information and acquires the distribution of the propagation losses taking into consideration the influence, such as reflection. As a method of the propagation simulation, for example, a ray tracing method is possible to be used. Furthermore, for example, the propagation loss acquiring unit 102 may also perform actual measurement of the propagation losses. An example of the distribution of the propagation losses acquired by the propagation loss acquiring unit 102 is illustrated in FIG. 7. FIG. 7 is a schematic diagram illustrating an example of the distribution of propagation losses according to the first embodiment.

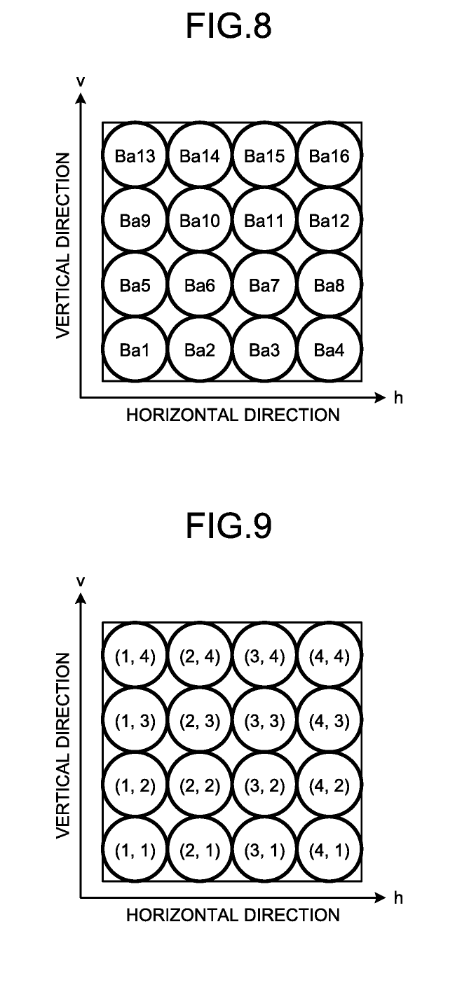

Then, the candidate beam set deciding unit 103 forms, as illustrated in FIG. 8, a candidate beam set from only the narrow candidate beams Ba1 to Ba16 (namely, wide candidate beams are not included) (Step S22). FIG. 8 is a schematic diagram illustrating a decision process of the candidate beam set according to the first embodiment. The narrow candidate beams Ba1 to Ba16 illustrated in FIG. 8 correspond to the candidate beams Ba1 to Ba16 illustrated in FIG. 2 and the emission directions of the narrow candidate beams Ba1 to Ba16 are different with each other. Furthermore, in the two-dimensional plane constituted from the horizontal direction (the direction of h) and the vertical direction (the direction of v), the emission directions of the narrow candidate beams Ba1 to Ba16 are associated with (h,v)=(1,1) to (4,4) illustrated in FIG. 9. FIG. 9 is a schematic diagram illustrating a decision process of the candidate beam set according to the first embodiment.

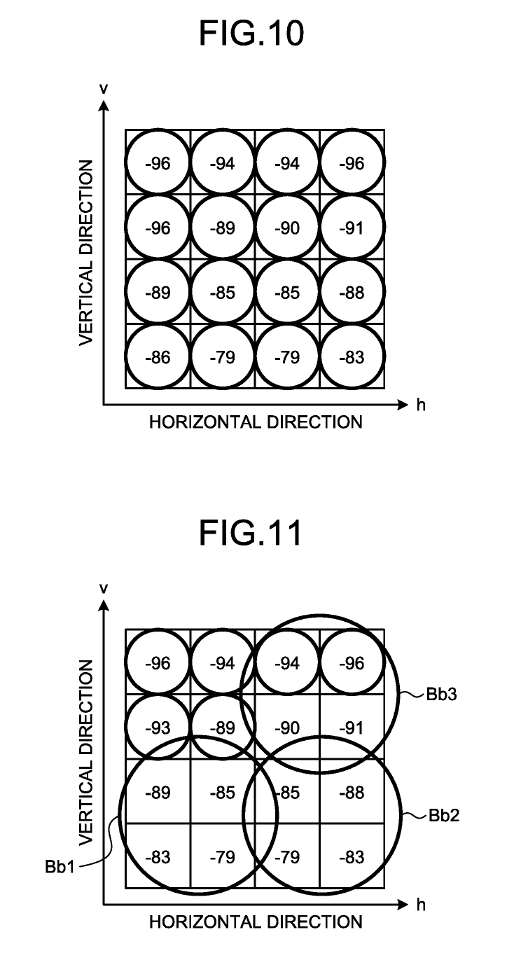

Then, on the basis of the distribution of the propagation losses acquired at Step S21, the candidate beam set deciding unit 103 estimates, in accordance with Equation (5), the RSRP in the user equipment 20 for each of the candidate beams included in the candidate beam set illustrated in FIG. 8 (Step S23). Here, P_{h,v} is the RSRP estimated in the emission direction (h, v), G₀ is the BF gain of the narrow candidate beam, P_{TX} is the transmission electrical power of the narrow candidate beam, and G₀ and P_{TX} are constant values. Furthermore, L_{h,v} is the propagation loss in the emission direction (h,v) and is the propagation loss in each of the emission directions (1,1) to (4,4) in the distribution of the propagation losses acquired at Step S21. Furthermore, for example, the minimum BF gain within the beam width is preferably used as G₀ and the maximum propagation loss within the beam width is preferably used as L_{h,v}. As an example, as G₀=12 dB and P_{TX}=20 dBm, P_{h,v} [dBm] estimated based on the distribution of the propagation losses illustrated in FIG. 7 is illustrated in FIG. 10. FIG. 10 is a schematic diagram illustrating an example of the estimation result of RSRP according to the first embodiment.

P_{h,v}=G₀+P_{TX}−L_{h,v} (5)

Here, in the emission direction in which the propagation losses are small, because it is assumed that high RSRP is possible to be obtained even if the BF gain is small, it is possible to use, as a candidate beam, the beam that has a small BF gain but that covers a wide region at a time, i.e., the beam that has a large beam width. For example, by changing the number of antenna elements that transmit the reference signals, the beam width is possible to be adjusted and thus the beam width is possible to be greater as the number of antenna elements that transmit the reference signals is decreased.

Thus, under the predetermined condition, the candidate beam set deciding unit 103 updates the candidate beam set by using the candidate beams in which a reduction of the number of candidate beams becomes the maximum (Step S24).

Namely, the candidate beam set deciding unit 103 removes a plurality of the narrow candidate beams from the candidate beam set and adds, to the candidate beam set, a single wide candidate beam that covers the same region as that covered by the plurality of removed narrow candidate beams. In this way, the candidate beam set deciding unit 103 replaces the plurality of narrow candidate beams with a single wide candidate beam.

However, the candidate beam set deciding unit 103 replaces the candidate beams in only the emission direction that satisfies the predetermined condition indicated by Equation (6) and does not replace the candidate beams in the emission direction that does not satisfy the condition indicated by Equation (6). In Equation (6), G₁ is the BF gain of the wide candidate beam, T_{P} is a threshold of the reception power, and G₁ is the constant value. Namely, the candidate beam set deciding unit 103 replaces the candidate beams in only the emission direction in which the RSRP of the wide candidate beams in the user equipment 20 is equal to or greater than the threshold. With this replacement, the number of candidate beams that form the candidate beam set is possible to be reduced. Furthermore, if a plurality of wide candidate beams that are possible to be replaced is present, it is preferable that the candidate beam set deciding unit 103 replace the candidate beams with the maximum number of narrow candidate beams that are targeted for the replacement.

P_{h,v}−(G₀−G₁)≧T_{P} (6)

Here, the threshold T_{P} is preferably set based on the reception power in which the channel estimation accuracy desired in the user equipment 20 is possible to be secured and is preferably set to the same reception power as the reception power in which the channel estimation accuracy desired in, for example, the user equipment 20 is possible to be secured. Furthermore, the threshold T_{P} is preferable set based on the reception power in which the throughput desired in the user equipment 20 is possible to be secured and is preferable set to the same reception power as the reception power in which the throughput desired in, for example, the user equipment 20 is possible to be secured.

Every time the candidate beam set deciding unit 103 replaces the candidate beams, the candidate beam set deciding unit 103 determines whether the number of candidate beams that form the candidate beam set is possible to be deleted (Step S25). If the deletion is possible (Yes at Step S25), the process returns to Step S24a and the candidate beam set deciding unit 103 again replaces the candidate beams. In contrast, the deletion is impossible (No at Step S25), the process is ended. Namely, the candidate beam set deciding unit 103 performs the process at Steps S22 to S25 and decides a candidate beam set that is formed by a plurality of candidate beams that have different emission directions with each other and that are formed by the narrow candidate beams and the wide candidate beams. Furthermore, by repeatedly performing the process at Steps S22 and S23, under the condition in which the RSRP in the user equipment 20 is equal to or greater than the threshold, the number of candidate beams that form the candidate beam set becomes the minimum. As described above, as the number of candidate beams is increased, an amount of consumption in the radio resources is increased. In contrast, as the number of candidate beams is decreased, an amount of consumption in the radio resources is decreased. Consequently, by repeatedly performing the processes at Steps S22 and S23, under the condition in which the RSRP in the user equipment 20 is equal to or greater than the threshold, an amount of radio resource occupied by the candidate beam set becomes the minimum.

An example of the candidate beam set decided in accordance with the flowchart illustrated in FIG. 6 is illustrated in FIG. 11. FIG. 11 is a schematic diagram illustrating an example of candidate beam sets according to the first embodiment. However, FIG. 11 is an example of a case of T_{P}=−98 dBm and G₁=6 dB. Namely, in FIG. 11, the four narrow candidate beams of Ba1, Ba2, Ba5, and Ba6 are replaced with a single wide candidate beam Bb1. Furthermore, the four narrow candidate beams of Ba3, Ba4, Ba1, and Ba8 are replaced with a single wide candidate beam Bb2. Furthermore, the two narrow candidate beams of Ba11 and Ba12 are replaced with a single wide candidate beam Bb3.

As described above, in the first embodiment, the base station 10 that performs beamforming on the user equipment 20 includes the propagation loss acquiring unit 102, the candidate beam set deciding unit 103, and the flat panel antenna 101. The propagation loss acquiring unit 102 acquires the distribution of the propagation losses in the sector S1 that is a communication area with the constant size. The candidate beam set deciding unit 103 decides a candidate beam set on the basis of the distribution of the propagation losses. Namely, the candidate beam set deciding unit 103 decides a candidate beam set formed from a plurality of the candidate beams that includes the candidate beams each having the beam width based on the distribution of the propagation losses (for example, narrow candidate beams and wide candidate beams). The flat panel antenna 101 transmits the reference signal to the user equipment 20 by using each of the beams included in the plurality of the candidate beams that form the candidate beam set.

By doing so, the beam widths of the respective candidate beams that form the candidate beam set are different with each other in accordance with the distribution of the propagation losses in the sector S1. Consequently, by increasing the beam width of the candidate beam with a small propagation loss in the emission direction, the number of candidate beams that fill the sector S1 is decreased. Thus, an amount of radio resources consumed by the beam search is decreased. Namely, the beam search is possible to be performed by the radio resources with the usage smaller than conventionally used. In other words, the beam search is possible to be performed in a period shorter than before with the same conventional usage of the radio resources.

Furthermore, the candidate beam set deciding unit 103 forms, based on the distribution of the propagation losses, under the condition in which the RSRP in the user equipment 20 is equal to or greater than the threshold, a candidate beam set from a plurality of the candidate beams such that an amount of radio resource occupied by the candidate beam set is the minimum.

By doing so, the beam search is possible to be performed with the minimum radio resource usage while securing the RSRP desired in the user equipment 20.

Furthermore, the threshold of the RSRP is set based on the reception power in which the channel estimation accuracy desired in the user equipment 20 is possible to be secured or based on the reception power in which the throughput desired in the user equipment 20 is possible to be secured.

By doing so, the beam search is possible to be performed with the usage of the radio resources smaller than before while securing the channel estimation accuracy or the throughput desired in the user equipment 20.

### [b] Second Embodiment

A second embodiment differs from the first embodiment in that the candidate beam set decided in the base station is formed by a plurality of candidate beams each having a different combination of the beam width and the sequence length of the reference signal that is targeted for transmission.

Configuration of the Base Station

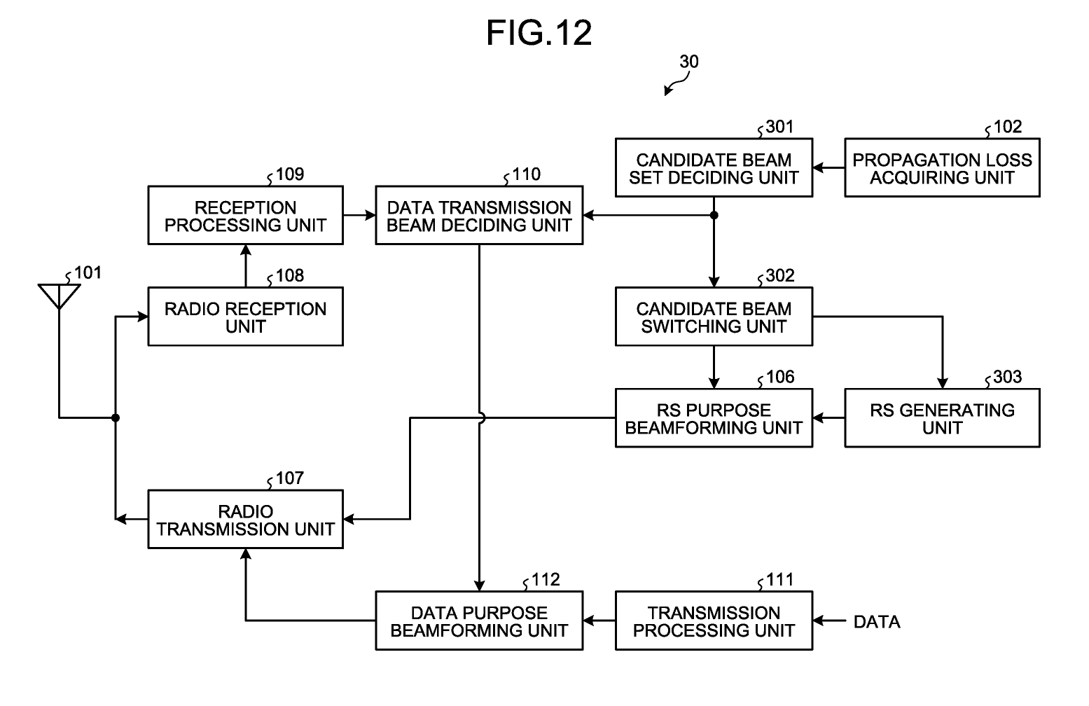

FIG. 12 is a functional block diagram illustrating an example of a base station according to a second embodiment. A base station 30 illustrated in FIG. 12 corresponds to the base station BS illustrated in FIGS. 1 and 2. In FIG. 12, the base station 30 includes the flat panel antenna 101, the propagation loss acquiring unit 102, a candidate beam set deciding unit 301, and a candidate beam switching unit 302. Furthermore, the base station 30 includes an RS generating unit 303, the RS purpose beamforming unit 106, the radio transmission unit 107, the radio reception unit 108, the reception processing unit 109, the data transmission beam deciding unit 110, the transmission processing unit 111, and the data purpose beamforming unit 112.

The candidate beam set deciding unit 301 decides the candidate beam set in the sector S1 on the basis of the distribution of the propagation losses acquired by the propagation loss acquiring unit 102 and instructs the candidate beam switching unit 302 and the data transmission beam deciding unit 110 of the decided candidate beam set. However, the candidate beam set deciding unit 301 is different from the candidate beam set deciding unit 103 according to the first embodiment in that the candidate beam set deciding unit 301 decides a candidate beam set by taking into consideration the sequence length of the reference signals. The decision of the candidate beam set will be described in detail later.

The candidate beam switching unit 302 instructs the RS purpose beamforming unit 106 of the candidate beams while sequentially changing, in accordance with elapse of time in a beam search, the candidate beams used for transmission of the reference signals from among a plurality of candidate beams that form a candidate beam set. Furthermore, the candidate beam switching unit 302 instructs the RS generating unit 303 of the sequence length of the reference signals targeted for transmission in each of the candidate beams in accordance with a change in the candidate beams.

The RS generating unit 303 generates, in accordance with the sequence length instructed from the candidate beam switching unit 302, a “short reference signal” having a predetermined sequence length or a “long reference signal” having a sequence length longer than that of the short reference signal and outputs the generated reference signal to the RS purpose beamforming unit 106.

Configuration of the User Equipment

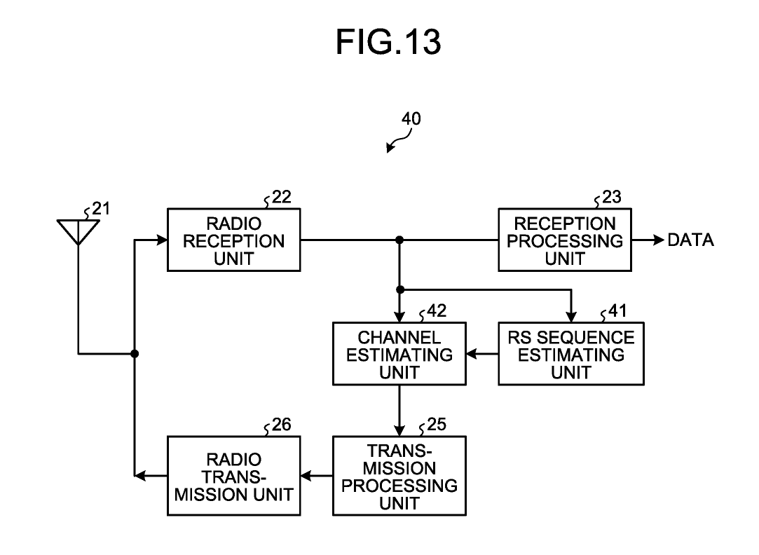

FIG. 13 is a functional block diagram illustrating an example of the user equipment according to the second embodiment. User equipment 40 illustrated in FIG. 13 corresponds to the user equipment UE1 and UE2 illustrated in FIGS. 1 and 2. In FIG. 13, the user equipment 40 includes the antenna 21, the radio reception unit 22, the reception processing unit 23, an RS sequence estimating unit 41, a channel estimating unit 42, the transmission processing unit 25, and the radio transmission unit 26.

The radio reception unit 22 performs a radio process of down-conversion and analog-to-digital conversion on the reference signal and the data signal received from the base station 30 via the antenna 21, obtains a baseband reference signal and a baseband data signal, and then outputs the obtained baseband signals to the reception processing unit 23, the RS sequence estimating unit 41, and the channel estimating unit 42.

The RS sequence estimating unit 41 previously stores therein the sequence of the short reference signals and the sequence of the long reference signals and calculates each of a first correlation value between the input reference signal and the sequence of the short reference signal and each of a second correlation value between the input reference signal and the sequence of the long reference signal. If the first correlation value is greater than the second correlation value, the RS sequence estimating unit 41 estimates that the reference signal transmitted from the base station 30 is the short reference signal. In contrast, if the second correlation value is greater than the first correlation value, the RS sequence estimating unit 41 estimates that the reference signal transmitted from the base station 30 is the long reference signal. The RS sequence estimating unit 41 instructs the channel estimating unit 42 of the sequence length of the estimated reference signal.

The channel estimating unit 42 performs channel estimation by using the reference signals in the estimation period in accordance with the sequence length instructed from the RS sequence estimating unit 41, generates report data that includes therein each of the channel estimated values of the plurality of the candidate beams to the transmission processing unit 25. For example, the channel estimating unit 42 measures the RSRP for each candidate beam as the channel estimated value. Alternatively, the channel estimating unit 42 measures, as the channel estimated value, the RSRP and the phase rotation amount for each candidate beam.

Process Performed in the Base Station

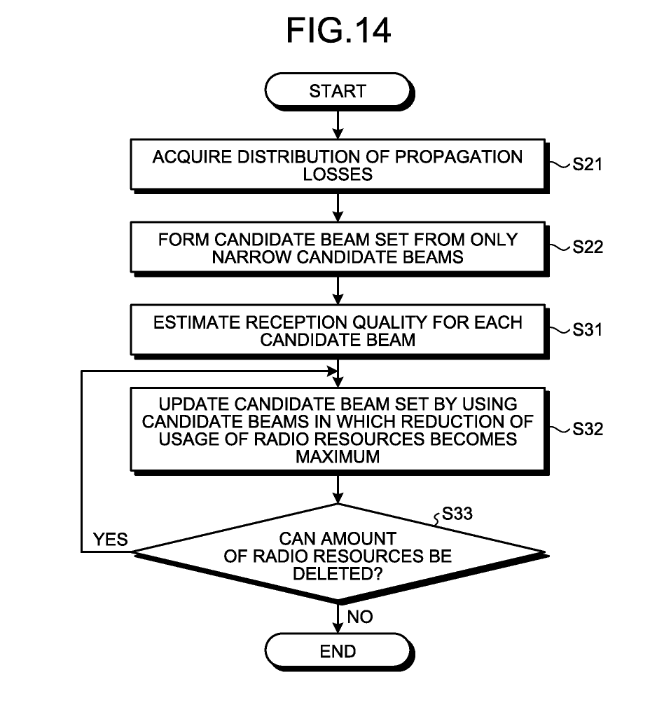

FIG. 14 is a flowchart illustrating the flow of a process performed in the base station according to the second embodiment. The flowchart illustrated in FIG. 14 is started at a predetermined interval.

In FIG. 14, the processes at Steps S21 and S22 are the same as those described in the first embodiment; therefore, descriptions thereof will be omitted.

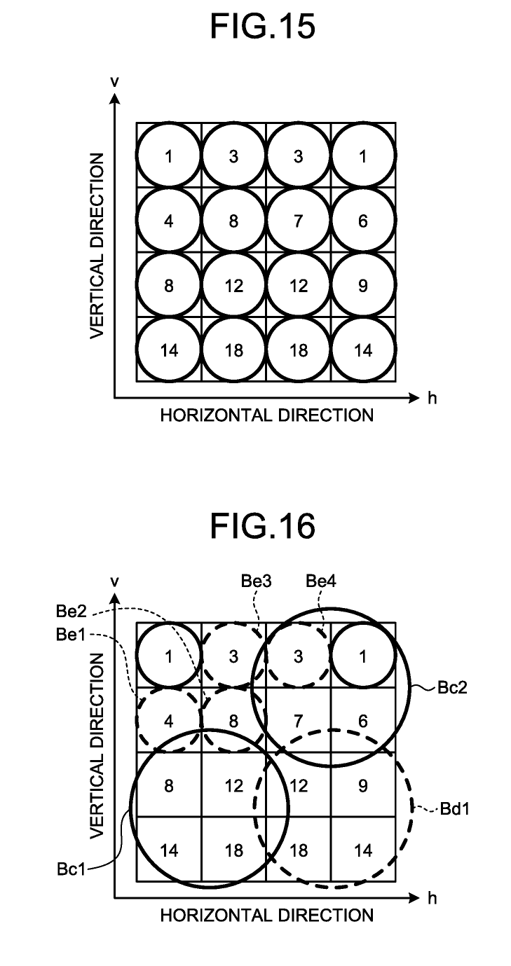

After having performed the process at Step S22, the candidate beam set deciding unit 301 estimates, in accordance with Equation (7) on the basis of the distribution of the propagation losses acquired at Step S21, the reception quality in the user equipment 40 for each of the candidate beams included in the candidate beam set illustrated in FIG. 8 (Step S31). Here, γ_{h,v} is reception quality estimated in the emission direction (h,v), N is expected noise electrical power, K₀ is the sequence length of the long reference signal, and N and K₀ are constant values. Namely, the candidate beam set deciding unit 301 estimates the reception quality of a case of transmitting the long reference signal by using the narrow candidate beam. As an example, as G₀=12 dB, P_{TX}=20 dBm, N=−76 dBm, and K₀=128, γ_{h,v} [dB] estimated based on the distribution of the propagation losses illustrated in FIG. 7 is illustrated in FIG. 15. FIG. 15 is a schematic diagram illustrating an example of the estimation result of the reception quality according to the second embodiment.

γ_{h,v}=G₀+P_{TX}−L_{h,v}−(N−10 log₁₀ K₀) (7)

Here, the usage of the radio resources using the reference signals is increased in a case of using a long reference signal compared with a case of using a short reference signal for the channel estimation, whereas the suppression effect of noise is increased because the estimation period of the channel estimated value becomes long; therefore, the channel estimation accuracy is improved. Consequently, in the emission direction in which a propagation loss is large, it is preferable to use the long reference signal in which the suppression effect of noise is large and, in contrast, in the emission direction in which a propagation loss is small, it is preferable to use the short reference signal in which the usage of the radio resources is small.

Thus, under the predetermined condition, the candidate beam set deciding unit 301 updates the candidate beam set by using the candidate beams in which the reduction of the usage of the radio resources becomes the maximum (Step S32).

Namely, the candidate beam set deciding unit 301 removes one or more candidate beams from the candidate beam set and adds, to the candidate beam set, the candidate beams that cover the same region as the region that was covered by one or more removed candidate beams and in which the usage of the radio resources is smaller than the one or more removed candidate beams. In this way, the candidate beam set deciding unit 301 replaces one or more candidate beams with the candidate beams that are possible to search the same region with the smaller radio resource usage. For example, the candidate beam set deciding unit 301 replaces a plurality of narrow candidate beams with a single wide candidate beam or replaces the candidate beam that transmits the long reference signal with the candidate beam that transmits the short reference signal.

However, the candidate beam set deciding unit 301 replaces the candidate beams only in the emission direction that satisfies the predetermined condition indicated by Equation (8) and does not replace the candidate beams in the emission direction that does not satisfy the condition indicated by Equation (8). In Equation (8), K₁ is the sequence length of the short reference signal, T_{γ} is the threshold of the reception quality, and K₁ is a constant value. Namely, the candidate beam set deciding unit 301 replaces the candidate beams only in the emission direction in which the reception quality of the replaced candidate beams in the user equipment 40 is equal to or greater than the threshold. With this replacement, an amount of radio resources occupied by the candidate beam set.

γ_{h,v}−(G₀−G₁)−10 log₁₀(K₀/K₁)≧T_{γ} (8)

Here, the threshold T_{γ} is preferably be set based on the reception quality in which the channel estimation accuracy desired in the user equipment 40 is possible to be secured and is preferably be set to the value equal to the reception quality in which, for example, the channel estimation accuracy desired in the user equipment 40 is possible to be secured. Alternatively, the threshold T_{γ} is preferably be set based on the reception quality in which the throughput desired in the user equipment 40 is possible to be secured and is preferably be set to the value equal to the reception quality in which, for example, the throughput desired in the user equipment 40 is possible to be secured.

Every time the candidate beam set deciding unit 301 replaces the candidate beams, the candidate beam set deciding unit 301 determines whether the usage of the radio resources due to the candidate beam set, i.e., the amount of radio resources occupied by the candidate beam set is possible to be deleted (Step S33). If the deletion is possible (Yes at Step S33), the process returns to Step S32a and the candidate beam set deciding unit 301 again replaces the candidate beams. In contrast, if the deletion is not possible (No at Step S33), the process is ended. By repeatedly performing the processes at Steps S32 and S33, under the condition in which the reception quality of the reference signal in the user equipment 40 is equal to or greater than the threshold, the amount of radio resource occupied by the candidate beam set becomes the minimum.

An example of the candidate beam set decided in accordance with the flowchart illustrated in FIG. 14 will be described with reference to FIG. 16. FIG. 16 is a schematic diagram illustrating an example of a candidate beam set according to the second embodiment. Here, FIG. 16 illustrates an example of a case of T_{γ}=0 dB, K₁=64, G₀=12 dB, and G₁=6 dB. Furthermore, in FIG. 16, the solid lines indicate the candidate beams that transmit the long reference signal and the dotted lines indicate the candidate beams that transmit the short reference signal. Namely, in FIG. 16, the four narrow candidate beams that transmit the long reference signals of Ba1, Ba2, Ba5, Ba6 are replaced with the single wide candidate beam Bc1 that transmits the long reference signal. Furthermore, the four narrow candidate beams that transmit the long reference signals of Ba3, Ba4, Ba1, and Ba8 are replaced with the single wide candidate beam Bd1 that transmits the short reference signal. Furthermore, the two narrow candidate beams that transmit the long reference signals of Ba11 and Ba12 are replaced with the single wide candidate beam Bc2 that transmits the long reference signal. Furthermore, the narrow candidate beams that transmits the long reference signals of Ba9, Ba10, Ba14, and Ba15 are replaced with the narrow candidate beams of Be1, Be2, Be3, Be4, respectively, that transmit the short reference signals.

As described above, in the second embodiment, the candidate beam set deciding unit 301 decides, based on the distribution of the propagation losses in the sector S1, the sequence length of each of the reference signals transmitted to the user equipment 40 by using each of the beams included in the plurality of the candidate beams that form the candidate beam set.

By doing so, by adjusting the sequence length of the reference signals, an amount of radio resources consumed by the beam search is changed even if the beam width is the same. Consequently, even if the emission direction in which the propagation losses is small is scattered, by using the short reference signal while still using the narrow beam, it is possible to perform a beam search with the usage of the radio resources smaller than in the past.

Furthermore, on the basis of the distribution of the propagation losses, under the condition in which the reception quality of the reference signals in the user equipment 40 is equal to or greater than the threshold, the candidate beam set deciding unit 301 forms the candidate beam set from the plurality of candidate beams in which the amount of radio resource occupied by the candidate beam set is the smallest.

By doing so, it is possible to perform a beam search with the minimum radio resource usage while securing the reception quality desired in the user equipment 40.

Furthermore, the threshold of the reception quality is set based on the reception quality in which the channel estimation accuracy desired in the user equipment 40 is possible to be secured or based on the reception quality in which the throughput desired in the user equipment 40 is possible to be secured.

By doing so, it is possible to perform a beam search with the usage of the radio resources smaller than in the past while securing the channel estimation accuracy or the throughput desired in the user equipment 40.

### [c] Third Embodiment

A third embodiment differs from the first embodiment in that a beam search is again performed on only specific user equipment UE.

Configuration of the Base Station

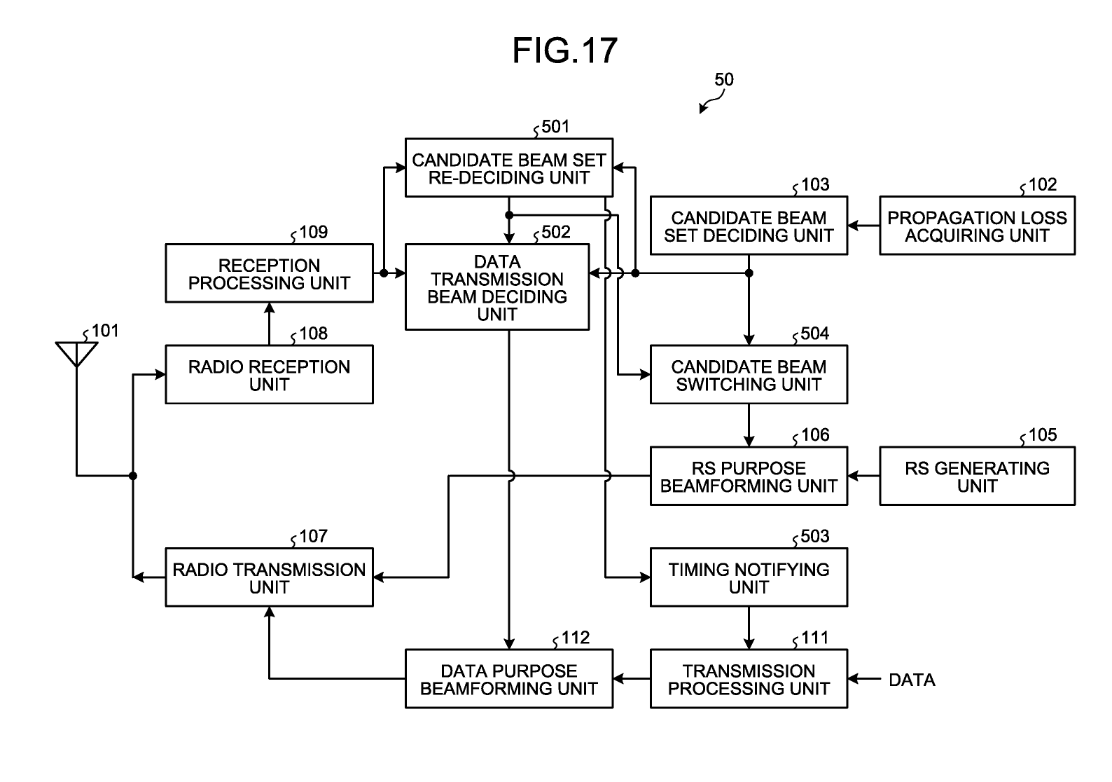

FIG. 17 is a functional block diagram illustrating an example of a base station according to a third embodiment. A base station 50 illustrated in FIG. 3 corresponds to the base station BS illustrated in FIGS. 1 and 2. In FIG. 17, the base station 50 includes the flat panel antenna 101, the propagation loss acquiring unit 102, and the candidate beam set deciding unit 103. Furthermore, the base station 50 includes the RS generating unit 105, the RS purpose beamforming unit 106, the radio transmission unit 107, the radio reception unit 108, the reception processing unit 109, the transmission processing unit 111, and the data purpose beamforming unit 112. Furthermore, the base station 50 includes a candidate beam set re-deciding unit 501, a data transmission beam deciding unit 502, a timing notifying unit 503, and a candidate beam switching unit 504.

The reception processing unit 109 outputs, to the candidate beam set re-deciding unit 501 and the data transmission beam deciding unit 502, the channel estimated value for each candidate beam reported from each of the pieces of the user equipment UE.

The candidate beam set deciding unit 103 instructs the candidate beam switching unit 504, the candidate beam set re-deciding unit 501, and the data transmission beam deciding unit 502 of the candidate beam set decided by performing the processes described in the first embodiment.

The candidate beam set re-deciding unit 501 again decides the candidate beam set with respect to only the specific user equipment UE that satisfies the predetermined condition of the relationship between the candidate beam set decided by the candidate beam set deciding unit 103 and the RSRP included in the channel estimated value. The candidate beam set re-deciding unit 501 instructs the candidate beam switching unit 504 and the data transmission beam deciding unit 502 of the candidate beam set that is re-decided with respect to the specific user equipment UE (hereinafter, sometimes referred to as a “re-decision candidate beam set”). Furthermore, the candidate beam set re-deciding unit 501 notifies the timing notifying unit 503 of the re-decision of the candidate beam set together with the identification information on the specific user equipment UE. The re-decision of the candidate beam set will be described in detail later.

The candidate beam switching unit 504 is different from the candidate beam switching unit 104 according to the first embodiment in the following point. Namely, if a re-decision candidate beam set is not instructed from the candidate beam set re-deciding unit 501, the candidate beam switching unit 504 switches the candidate beams in the plurality of candidate beams that form the candidate beam set decided by the candidate beam set deciding unit 103. In contrast, if the candidate beam switching unit 504 receives an instruction of the re-decision candidate beam set from the candidate beam set re-deciding unit 501, the candidate beam switching unit 504 switches the candidate beams in the plurality of candidate beams that form the re-decision candidate beam set.

The data transmission beam deciding unit 502 is different from the data transmission beam deciding unit 110 according to the first embodiment in the following point. Namely, if no instruction of the re-decision candidate beam set is received from the candidate beam set re-deciding unit 501, the data transmission beam deciding unit 502 decides the data transmission beams based on the candidate beam set that is decided by the candidate beam set deciding unit 103. In contrast, if the instruction of the re-decision candidate beam set is received from the candidate beam set re-deciding unit 501, the data transmission beam deciding unit 502 decides the data transmission beams on the basis of the subject re-decision candidate beam set. Furthermore, the decision method of the data transmission beams is the same as that described in the first embodiment.

When the re-decision of the candidate beam set is notified from the candidate beam set re-deciding unit 501, the timing notifying unit 503 generates a “timing notification” that is used to instruct the timing in which the channel estimation of the specific user equipment UE that has been subjected to the re-decision of the candidate beam set. In the timing notification, the identification information on the specific user equipment UE in which re-decision of the candidate beam set has been performed is included. The timing notifying unit 503 outputs the generated timing notification to the transmission processing unit 111.

In addition to the processes described in the first embodiment, the transmission processing unit 111 generates a baseband communication signal by performing a baseband process of encoding and modulating the timing notification and then outputs the generated baseband communication signal to the data purpose beamforming unit 112.

Configuration of the User Equipment

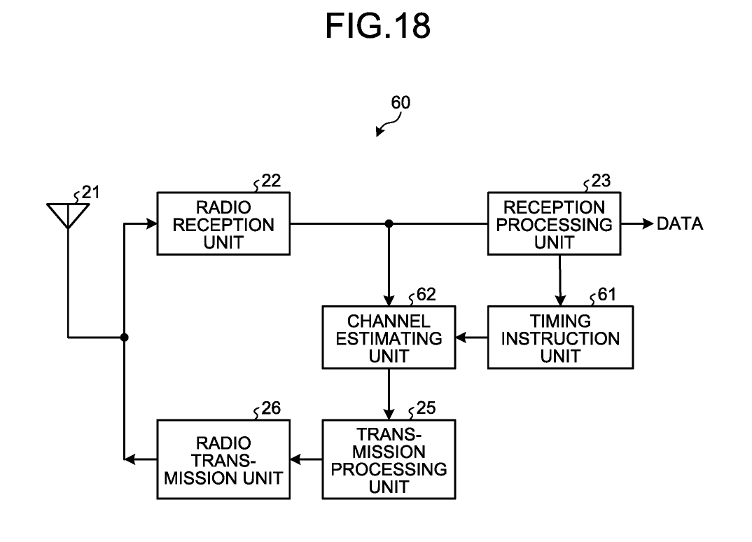

FIG. 18 is a functional block diagram illustrating an example of user equipment according to the third embodiment. User equipment 60 illustrated in FIG. 18 corresponds to the user equipment UE1 and UE2 illustrated in FIGS. 1 and 2. In FIG. 18, the user equipment 60 includes the antenna 21, the radio reception unit 22, the reception processing unit 23, the transmission processing unit 25, and the radio transmission unit 26. Furthermore, the user equipment 60 includes a timing instruction unit 61 and a channel estimating unit 62.

In addition to the processes described in the first embodiment, the radio reception unit 22 performs a radio process of down-conversion and analog-to-digital conversion on the communication signal received from the base station 50 via the antenna 21, obtains a baseband communication signal, and outputs the obtained baseband communication signal to the reception processing unit 23.

In addition to the processes described in the first embodiment, the reception processing unit 23 performs a baseband process of demodulating and decoding on the baseband communication signal, obtains a timing notification, and outputs the obtained timing notification to the timing instruction unit 61.

The timing instruction unit 61 determines whether the timing notification that is input from the reception processing unit 23 is addressed to the own equipment and, if the timing notification is addressed to the own equipment, the timing instruction unit 61 instructs the channel estimating unit 62 of the execution timing of the channel estimation notified by the timing notification. The timing instruction unit 61 determines, based on the identification information included in the timing notification, whether the timing notification is addressed to the own equipment.

The channel estimating unit 62 performs the following process in addition to the process performed by the channel estimating unit 24 described in the first embodiment. Namely, the channel estimating unit 62 again performs channel estimation for each candidate beam at the execution timing instructed from the timing instruction unit 61. The channel estimation performed at the execution timing instructed from the timing instruction unit 61 is performed based on the reference signals transmitted by using the candidate beams that form the re-decision candidate beam set.

Process in the Communication System

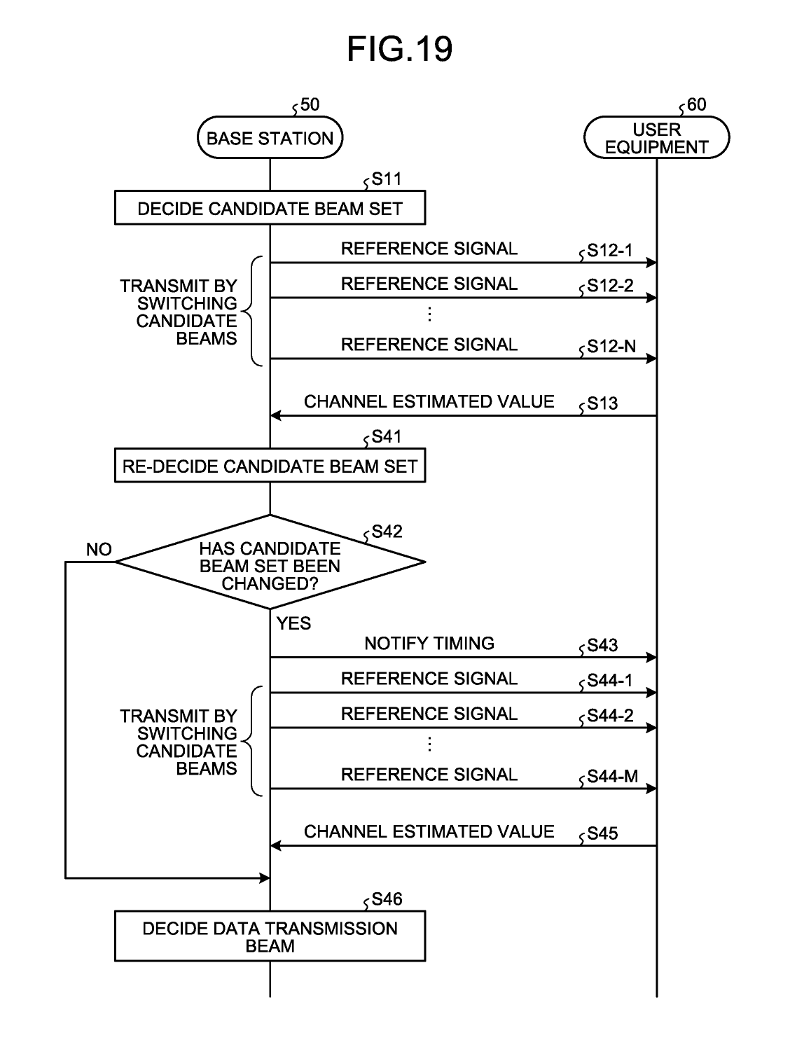

FIG. 19 is a schematic diagram illustrating an example of the processing sequence in a communication system according to the third embodiment. In FIG. 19, the processes at Steps S11 to S13 are the same as those described in the first embodiment; therefore, descriptions thereof will be omitted.

At Step S41, if the relationship between the candidate beam set decided at Step S11 and the RSRP for each candidate beam reported at Step S13 satisfies the predetermined condition, the base station 50 re-decides the candidate beam set (Step S41).

Then, the base station 50 determines whether there is a change in the candidate beam set, i.e., if the candidate beam set has been re-decided at Step S41 (Step S42).

Thus, if there is no change in the candidate beam set (No at Step S42), the base station 50 decides the data transmission beams based on the channel estimated value for each candidate beam reported at Step S13 (Step S46).

In contrast, if there is a change in the candidate beam set (Yes at Step S42), the base station 50 transmits, to the user equipment 60, the timing notification that is used to instruct the timing of the channel estimation (Step S43).

Then, the base station 50 transmits the reference signals by switching the candidate beams in the re-decision candidate beam set (Steps S44-1 to S44-M, where M is the number of candidate beams that form the re-decision candidate beam set).

Then, the user equipment 60 reports the base station 50 of the channel estimated value for each candidate beam included in the re-decision candidate beam set (Step S45).

Consequently, if there is a change in the candidate beam set (Yes at Step S42), the base station 50 decides the data transmission beam based on the channel estimated value for each candidate beam that has been reported at Step S45 (Step S46).

Process Performed in the Base Station

Because there is a possibility that the candidate beam set decided in the first embodiment includes a wide candidate beam, the beam width of the data transmission beam decided by the beam search is possible to possibly be large. Because the BF gain of the data signal is increased as the beam width of the data transmission beam is smaller, if the candidate beam set includes the wide candidate beam, there is a possibility that the BF gain of the data signal is decreased. Furthermore, regarding the user equipment UE in which the RSRP in the wide candidate beam included in the candidate beam set is the maximum, there is a possibility that the RSRP in the narrow candidate beam that has not been replaced with the subject wide candidate beam is greater than the RSRP in the wide candidate beam. Thus, in the third embodiment, regarding the user equipment UE in which the RSRP in the wide candidate beam in the candidate beam set is the maximum, the candidate beam set re-deciding unit 501 re-decides the candidate beam set as follows, thereby re-searching for a beam by using the narrow candidate beam.

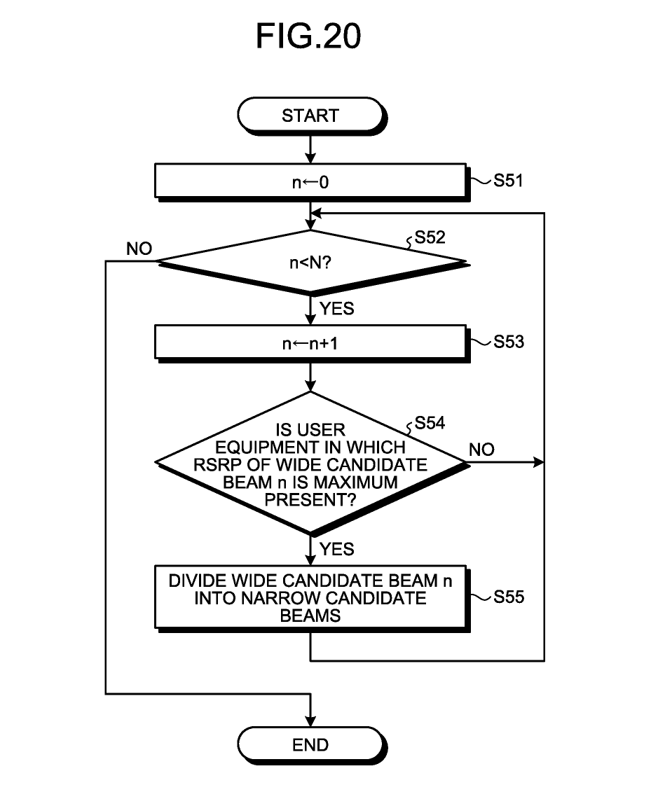

FIG. 20 is a flowchart illustrating the flow of a process performed in the candidate beam set re-deciding unit according to the third embodiment. The flowchart illustrated in FIG. 20 is started when the candidate beam set decided by the candidate beam set deciding unit 103 is instructed to the candidate beam set re-deciding unit 501.

First, the candidate beam set re-deciding unit 501 sets the variable n to “0” that is the initial value (Step S51).

Then, the candidate beam set re-deciding unit 501 determines whether n is less than N (Step S52). Here, N is the number of wide candidate beams included in the candidate beam set decided by the candidate beam set deciding unit 103. If n is not less than N, i.e., at the time when n is equal to or greater than N (No at Step S52), the process is ended.

In contrast, if n is less than N (Yes at Step S52), the candidate beam set re-deciding unit 501 increments n by one (Step S53).

Then, the candidate beam set re-deciding unit 501 determines whether the user equipment UE that satisfies the predetermined condition of the relationship between the candidate beam set decided by the candidate beam set deciding unit 103 and the RSRP for each candidate beam is present. Namely, the candidate beam set re-deciding unit 501 determines whether the user equipment UE in which the RSRP of the wide candidate beam n from among all of the candidate beams that form the candidate beam set is the maximum is present (Step S54). If the subject user equipment UE is not present (No at Step S54), the process returns to Step S52a and, if the subject user equipment UE is present (Yes at Step S54), the process proceeds to Step S55.

At Step S55, the candidate beam set re-deciding unit 501 re-decides the candidate beam set with respect to the user equipment UE in which the RSRP of the wide candidate beam n is the maximum. Namely, the candidate beam set re-deciding unit 501 divides the wide candidate beam n into a plurality of narrow candidate beams that cover the same region as that covered by the subject wide candidate beam n and then decides the candidate beam set that is formed by only the plurality of divided narrow candidate beams as a new candidate beam set (Step S55). However, the candidate beam set re-deciding unit 501 preferably excludes, from the re-decision candidate beam set, the reference signals that have already been used at Steps S12-1 to S12-N (FIG. 19) from among the plurality of divided narrow candidate beams. After having performed the process at Step S55, the process returns to Step S52.

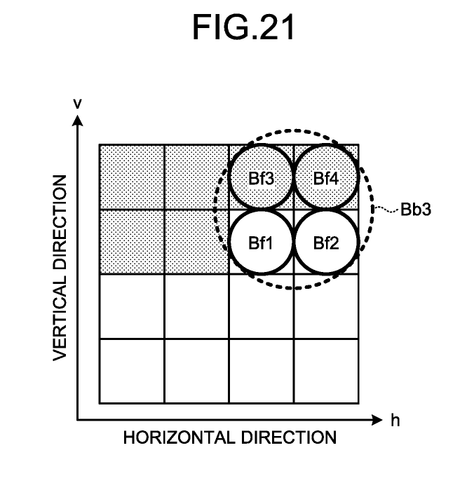

An example of the candidate beam set that has re-decided in accordance with the flowchart illustrated in FIG. 20 is illustrated in FIG. 21. FIG. 21 is a schematic diagram illustrating an example of a re-decision candidate beam set according to the third embodiment. FIG. 21 illustrates, as an example, candidate beam set that has been re-decided with respect to the user equipment UE in which the RSRP of the wide candidate beam Bb3 in the candidate beam set illustrated in FIG. 11 described in the first embodiment is the maximum. The emission direction indicated by the hatching illustrated in FIG. 21 is the emission direction in which the reference signals have already been transmitted by using the narrow candidate beams in the first embodiment (FIG. 11).

If the wide candidate beam Bb3 is divided into a plurality of narrow candidate beams that cover the same region as that covered by the wide candidate beam Bb3, the wide candidate beam Bb3 is divided into four narrow candidate beams of Bf1 to Bf4. Thus, regarding the user equipment UE in which the RSRP of the wide candidate beam Bb3 is the maximum, the candidate beam set re-deciding unit 501 forms a new candidate beam set from only the narrow candidate beams Bf1 to Bf4. Consequently, the reference signals are retransmitted from the flat panel antenna 101 by only using the narrow candidate beams Bf1 to Bf4.

However, from among the divided narrow candidate beams Bf1 to Bf4, the narrow candidate beams Bf3 and Bf4 have already been used to transmit the reference signals when the beam search is performed first time. Thus, it is preferable that the candidate beam set re-deciding unit 501 form a new candidate beam set from only the remaining narrow candidate beams Bf1 and Bf2 obtained by excluding the narrow candidate beams Bf3 and Bf4 from the divided narrow candidate beams Bf1 to Bf4.

As described above, in the third embodiment, the candidate beam set re-deciding unit 501 divides, based on the RSRP in the user equipment 60, the wide candidate beam included in the candidate beam set into the narrow candidate beams. The flat panel antenna 101 retransmits the reference signals to the user equipment 60 by only using the divided narrow candidate beams.

By doing so, it is possible to re-search for the beams by using the narrow candidate beams by limiting to the emission direction in which a more detailed beam search is desired to be performed. Consequently, it is possible to decide optimum data transmission beams for each of the pieces of user equipment UE while suppressing an increase in the usage of the radio resources.

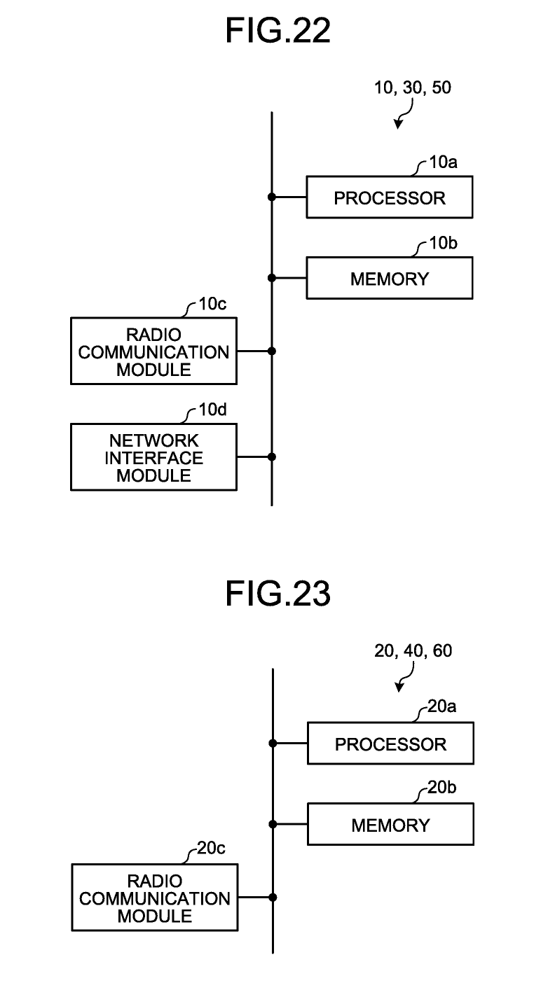

### [d] Another Embodiment

[1] If the distribution of the propagation losses acquired by the propagation loss acquiring unit 102 is acquired without using information, such as the momentary distribution state of the user equipment UE, or the like, that varies in a short period, the decision of the candidate beam set may also be performed in a long period, for example, once in every several days.

[2] The third embodiment may also be performed in combination with the second embodiment.

[3] The base station may also be referred to as an “access point”.

[4] In the embodiments described above, regarding the width of the candidate beams, two types of the candidate beams, i.e., the narrow candidate beams and the wide candidate beams, are used as an example. Furthermore, regarding the sequence length of the reference signals, two types of the reference signals, i.e., the long reference signals and the short reference signals, are used as an example. However, the width of the candidate beams and the sequence length of the reference signals may also be three or more types.

[5] In the embodiments described above, as an example of a wide candidate beam, a circular candidate beam is used. However, the shape of the wide candidate beam may also be an oval. For example, there may also be a case in which the four narrow candidate beams Ba1, Ba2, Ba3, and Ba4 illustrated in FIG. 8 are replaced with a single wide candidate beam.

[6] The antenna included in the base station BS is not limited to the flat panel antenna. The antenna included in the base station BS may also be any antenna that is possible to perform beamforming.

[7] The base stations 10, 30, and 50 and the user equipment 20, 40, and 60 are not always physically configured as illustrated in the drawings. Namely, the specific shape of a separate or integrated functioning unit is not limited to the drawings. Specifically, all or part of the functioning unit are possible to be configured by functionally or physically separating or integrating any of the units depending on various loads or use conditions. For example, the candidate beam set deciding unit 103 and the candidate beam set re-deciding unit 501 may also be integrated as a single functioning unit.

[8] The base stations 10, 30, and 50 are possible to be implemented by the following hardware configuration. FIG. 22 is a schematic diagram illustrating an example of the hardware configuration of the base station. As illustrated in FIG. 22, the base stations 10, 30, and 50 include, as hardware components, a processor 10a, a memory 10b, a radio communication module 10c, and a network interface module 10d. An example of the processor 10a includes a central processing unit (CPU), a digital signal processor (DSP), a field programmable gate array (FPGA), or the like. Furthermore, the base station 10 may also include a Large Scale Integrated (LSI) circuit that includes therein the processor 10a and a peripheral circuit. An example of the memory 10b includes a RAM, such as an SDRAM, or the like, ROM, flash memory, or the like.

The flat panel antenna 101, the radio transmission unit 107, and the radio reception unit 108 are implemented by the radio communication module 10c. The propagation loss acquiring unit 102, the candidate beam set deciding units 103 and 301, the candidate beam switching units 104, 302, and 504, the RS generating units 105 and 303, the RS purpose beamforming unit 106, the reception processing unit 109, the data transmission beam deciding units 110 and 502, the transmission processing unit 111, the data purpose beamforming unit 112, the candidate beam set re-deciding unit 501, and the timing notifying unit 503 are implemented by the processor 10a.

[9] The user equipment 20, 40, and 60 are possible to be implemented by the following hardware configuration. FIG. 23 is a schematic diagram illustrating an example of the hardware configuration of the user equipment. As illustrated in FIG. 23, the user equipment 20, 40, and 60 includes, as hardware components, a processor 20a, a memory 20b, and a radio communication module 20c. An example of the processor 20a includes a CPU, a DSP, an FPGA, or the like. Furthermore, the user equipment 20 may also include an LSI that includes therein the processor 20a and a peripheral circuit. An example of the memory 20b includes a RAM, such as an SDRAM, or the like, a ROM, a flash memory, or the like.

The antenna 21, the radio reception unit 22, and the radio transmission unit 26 are implemented by the radio communication module 20c. The reception processing unit 23, the channel estimating units 24, 42, and 62, the RS sequence estimating unit 41, and the timing instruction unit 61 are implemented by the processor 20a.

According to an aspect of an embodiment of the present invention, an amount of radio resources consumed by a beam search are possible to be reduced.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A base station that performs beamforming on a user equipment, the base station comprising:
an acquiring unit that acquires a distribution of propagation losses in a communication area;
a deciding unit that decides a beam set formed by a plurality of beams that are used for channel estimation, each of the beams having a beam width based on the distribution; and
an antenna that transmits a reference signal to the user equipment by using each of the beams that form the beam set.

2. The base station according to claim 1, wherein the deciding unit forms, based on the distribution, under a condition in which reception power of the reference signal in the user equipment is equal to or greater than a threshold, the beam set from the beams in which an amount of radio resource occupied by the beam set is minimum.

3. The base station according to claim 2, wherein the threshold is set based on the reception power in which a channel estimation accuracy desired in the user equipment is possible to be secured or based on the reception power in which a throughput desired in the user equipment is possible to be secured.

4. The base station according to claim 1, wherein the deciding unit decides, based on the distribution, a sequence length of the reference signal transmitted to the user equipment by using each of the beams.

5. The base station according to claim 4, wherein the deciding unit forms, based on the distribution, under a condition in which reception quality of the reference signal in the user equipment is equal to or greater than a threshold, the beam set from the beams in which an amount of radio resource occupied by the beam set is minimum.

6. The base station according to claim 5, wherein the threshold is set based on the reception quality in which a channel estimation accuracy desired in the user equipment is possible to be secured or based on the reception quality in which a throughput desired in the user equipment is possible to be secured.

7. The base station according to claim 1, wherein
the deciding unit divides, based on the reception power of the reference signal in the user equipment, a first beam included in the beam set into second beams that have a beam width smaller than the beam width of the first beam, and
the antenna retransmits the reference signal to the user equipment by using only the divided second beams.

8. A communication system comprising:
a user equipment; and
a base station that performs beamforming on the user equipment, wherein
the base station acquires a distribution of propagation losses in a communication area, decides a beam set formed by a plurality of beams that are used for channel estimation, and transmits a reference signal to the user equipment by using each of the beams that form the beam set, each of the beams having a beam width based on the distribution,
the user equipment performs channel estimation for each of the beams by using the reference signal and reports a channel estimated value for each of the beams to the base station, and
the base station decides, by using the channel estimated value for each of the beams, a beam used for data transmission.

9. A reference signal transmission method performed in a base station that performs beamforming on a user equipment, the reference signal transmission method comprising:
acquiring a distribution of propagation losses in a communication area;
deciding a beam set formed by a plurality of beams that are used for channel estimation, each of the beams having a beam width based on the distribution; and
transmitting a reference signal to the user equipment by using each of the beams that form the beam set.
